(19) United States
(12) Patent Application Publication
(10) Pub. No.: US 2015/0043826 A1
(43) Pub. Date: Feb. 12, 2015

(54) IMAGE PROCESSING APPARATUS, IMAGE PROCESSING METHOD, AND PROGRAM

(71) Applicant: SONY CORPORATION, Tokyo (JP)

(72) Inventor: HAJIME ISHIMITSU, Kanagawa (JP)

(21) Appl. No.: 14/444,127

(22) Filed: Jul. 28, 2014

(30) Foreign Application Priority Data
Aug. 7, 2013 (JP) 2013-163718

(51) Int. Cl. G06K 9/62; G06T 7/00

(52) U.S. Cl. CPC G06K 9/6232; G06T 7/004
USPC 382/190

(57) ABSTRACT

Provided is an image processing apparatus, including: an image processor configured to process an image of a first frame based on depth information of the first frame and depth information of a second frame before the first frame, the depth information indicating a position of an object in an image in a depth direction.

### CROSS REFERENCE TO RELATED APPLICATIONS

This application claims the benefit of Japanese Priority Patent Application JP 2013-163718 filed Aug. 7, 2013, the entire contents of which are incorporated herein by reference.

### BACKGROUND

The present disclosure relates to an image processing apparatus, an image processing method, and a program. Specifically, the present disclosure relates to an image processing apparatus, an image processing method, and a program capable of easily optimizing image processing based on depth information.

In general, an image storage device compresses image data, and stores the compressed image data to reduce the data volume at a minimum and to store data longer in time.

In the compression processing, it is important to accurately distinguish an area, to which a larger number of codes are allocated to inhibit the image quality from being deteriorated, from the other area. As a result, it is possible to inhibit the image quality from being deteriorated and to increase the compression rate at the same time.

An example of a method of distinguishing such areas from one another is a method of analyzing an uncompressed image, detecting information (e.g., presence/absence of high-frequency components, face area, difference in time direction, etc.), and determining an area based on the information. For example, in the case where the frequency of a whole uncompressed image is analyzed to detect presence/absence of high-frequency components, an area having high-frequency components is defined as a noteworthy area, i.e., an area to which a larger number of codes are allocated. Further, in the case where a face area is detected from an uncompressed image, the face area is defined as an area having a main object, i.e., an area to which a larger number of codes are allocated. According to this method, because it is necessary to analyze an uncompressed image to determine an area to which a larger number of codes are allocated, the processing amount is large.

An example of the method of detecting a predetermined area such as a face area is a method of detecting a person area based on a distance image generated based on values of a plurality of ranging points obtained by a ranging device employing an external-light passive method (for example, see Japanese Patent Application Laid-open No. 2005-12307).

Meanwhile, there is known a camera employing an image-plane phase-difference autofocus method. According to this method, an image sensor obtains an image and a depth map representing the phase difference of an image in a unit larger than a pixel, and focusing is performed rapidly and accurately.

### SUMMARY

As described above, the processing amount of the method of analyzing an uncompressed image, determining an area to which a larger number of codes are allocated, and compressing the image is large. That is, the processing amount of a method of optimizing image processing such as, for example, compression processing based on an image is large. As a result, the size of a circuit of an image processing apparatus configured to process an image is large and the circuit consumes a large amount of power in order to optimize image processing accurately and rapidly.

In view of the above-mentioned circumstances, it is desirable to reduce the size, the weight, and the cost of the image processing apparatus by optimizing image processing easily based on depth information. The depth information indicates a position of an object in the depth direction (i.e., direction perpendicular to imaging plane). An example of the depth information is a depth map. The depth map has a smaller number of samples than an image.

In view of the above-mentioned circumstances, it is desirable to optimize image processing easily based on depth information.

According to an embodiment of the present disclosure, there is provided an image processing apparatus, including: an image processor configured to process an image of a first frame based on depth information of the first frame and depth information of a second frame before the first frame, the depth information indicating a position of an object in an image in a depth direction.

Each of an image processing method according to an embodiment of the present disclosure and a program according to an embodiment of the present disclosure corresponds to the image processing apparatus according to the embodiment of the present disclosure.

According to the embodiment of the present disclosure, an image of a first frame is processed based on depth information of the first frame and depth information of a second frame before the first frame, the depth information indicating a position of an object in an image in a depth direction.

According to the embodiment of the present disclosure, it is possible to optimize image processing easily based on depth information.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing an example of the configuration of an image processing apparatus according to a first embodiment of the present disclosure;

FIG. 2 is a diagram showing an example of a taken image;

FIG. 3 is a diagram showing an example of a depth map of the taken image of FIG. 2;

FIG. 4 is a flowchart illustrating still-image shooting processing executed by the image processing apparatus;

FIG. 5 is a flowchart illustrating priority-map generation processing of FIG. 4 in detail;

FIG. 6 is a flowchart illustrating moving-image shooting processing executed by the image processing apparatus; and

FIG. 7 is a block diagram showing an example of configuration of hardware of a computer.

### DETAILED DESCRIPTION OF EMBODIMENTS

Hereinafter, an embodiment of the present disclosure will be described with reference to the drawings.

### First Embodiment

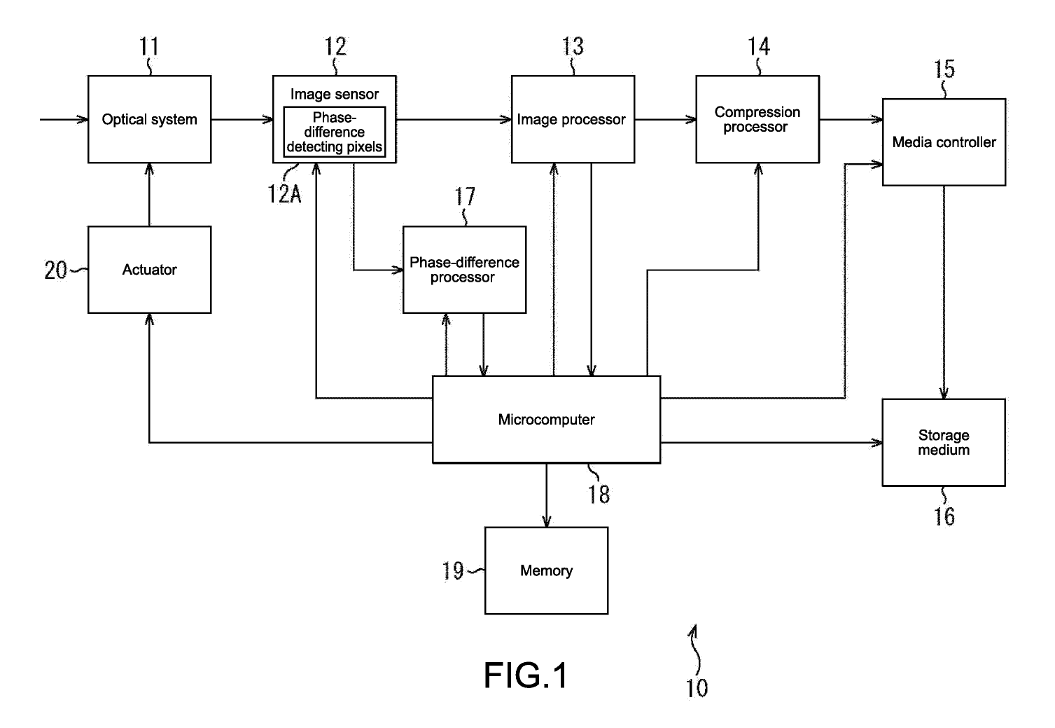

(Example of configuration of image processing apparatus according to first embodiment) FIG. 1 is a block diagram showing an example of the configuration of an image processing apparatus according to a first embodiment of the present disclosure.

The image processing apparatus 10 of FIG. 1 includes the optical system 11, the image sensor 12, the image processor 13, the compression processor 14, the media controller 15, the storage medium 16, the phase-difference processor 17, the microcomputer 18, the memory 19, and the actuator 20. The image processing apparatus 10 obtains an image and phase-difference information. The phase-difference information indicates the displacement of the image from the focal plane as a phase difference in a unit larger than a pixel (hereinafter referred to as “detection unit”). The image processing apparatus 10 compresses the image based on the phase-difference information.

Specifically, the optical system 11 includes a lens, a diaphragm, and the like. In the optical system 11, the image sensor 12 collects light from an object. The actuator 20 actuates the optical system 11.

The image sensor 12 includes the phase-difference detecting pixels 12A. The image sensor 12 photoelectrically converts the light collected by the optical system 11 in a pixel unit, to thereby obtain electric signals of the respective pixels of a still image or a moving image. At this time, the phase-difference detecting pixels 12A generate phase-difference information in a detection unit based on the light collected by the optical system 11, and supply the phase-difference information to the phase-difference processor 17. The image sensor 12 supplies the electric signals of the respective pixels to the image processor 13. Note that, hereinafter, if it is not necessary to distinguish a still image and a moving image from one another, they are collectively referred to as “taken image”.

Because the phase-difference detecting pixels 12A generate the phase-difference information based on the light collected by the optical system 11, the phase-difference detecting pixels 12A are capable of obtaining phase-difference information of an image being obtained now in real time.

The image processor 13 performs image processing, e.g., converts analog electric signals of the respective pixels supplied from the image sensor 12 to digital data of the respective pixels (i.e., image data).

The image processor 13 supplies the image data to the compression processor 14 and the microcomputer 18.

The compression processor 14 functions as an image processor. The compression processor 14 compresses the image data supplied from the image processor 13 based on a code-allocation priority map supplied from the microcomputer 18. Note that the code-allocation priority map shows priority of codes allocated to the respective pixels. The compression processor 14 allocates a larger number of codes to a pixel having higher priority in the code-allocation priority map, and compresses image data.

For example, JPEG (Joint Photographic Experts Group) is one of the methods of compressing still image data. Examples of a method of compressing moving image data include MPEG-2 (Moving Picture Experts Group phase 2), MPEG-4, and the like. The compression processor 14 supplies the compressed image data to the media controller 15.

The media controller 15 controls the storage medium 16, and stores the compressed image data supplied from the compression processor 14 in the storage medium 16. The storage medium 16 is controlled by the media controller 15, and stores the compressed image data.

The phase-difference processor 17 generates a depth map, and supplies the depth map to the microcomputer 18. The depth map includes phase-difference information of a taken image supplied from the phase-difference detecting pixels 12A in a detection unit.

The microcomputer 18 controls the respective blocks of the image processing apparatus 10. For example, the microcomputer 18 supplies the depth map supplied from the phase-difference processor 17 and the image data supplied from the image processor 13 to the memory 19.

Further, the microcomputer 18 functions as a detecting unit, and detects a main-object area based on the depth map. The main-object area is an area of a main object in a taken image. The microcomputer 18 generates a code-allocation priority map based on the main-object area.

Further, if a taken image is a moving image, the microcomputer 18 reads image data of a frame previous to the current frame of a moving image from the memory 19. Then, for example, the microcomputer 18 matches the image data of the moving image of the current frame to the image data of the moving image of the previous frame, to thereby detect a motion vector. Then the microcomputer 18 generates a code-allocation priority map based on the motion vector.

Note that, hereinafter, a code-allocation priority map generated based on a depth map will be referred to as “phase-code-allocation priority map”, and a code-allocation priority map generated based on a motion vector will be referred to as “motion-code-allocation priority map”, which are distinguished from one another.

The microcomputer 18 supplies the phase-code-allocation priority map and the motion-code-allocation priority map to the compression processor 14.

Further, the microcomputer 18 controls the actuator 20 based on the depth map such that a focal position Fcs moves by an amount inverse to a displacement amount represented by phase-difference information of a position selected by a user. As a result, it is possible to take an image in which a position selected by a user is in focus. Note that, for example, a user touches a predetermined position of a taken image displayed on a display unit integrated with a touchscreen (not shown), to thereby select the position as a position in focus.

The memory 19 is a work area for the microcomputer 18. The memory 19 stores halfway results and final results of processing executed by the microcomputer 18. For example, the memory 19 stores the depth map and the image data supplied from the microcomputer 18.

The actuator 20 is controlled by the microcomputer 18. The actuator 20 actuates the optical system 11, and controls a focal position Fcs, an aperture value Iris, and a zoom factor Zm.

(Example of Taken Image)

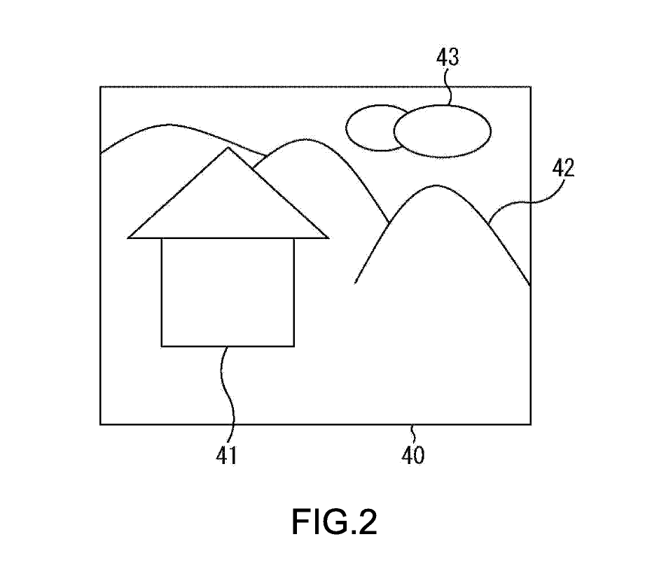

FIG. 2 is a diagram showing an example of a taken image.

In the taken image 40 of FIG. 2, the house 41 is foreground, and the mountains 42 and the cloud 43 are background. Further, the house 41 is the main object in the taken image 40, and the house 41 is in focus.

(Example of Depth Map)

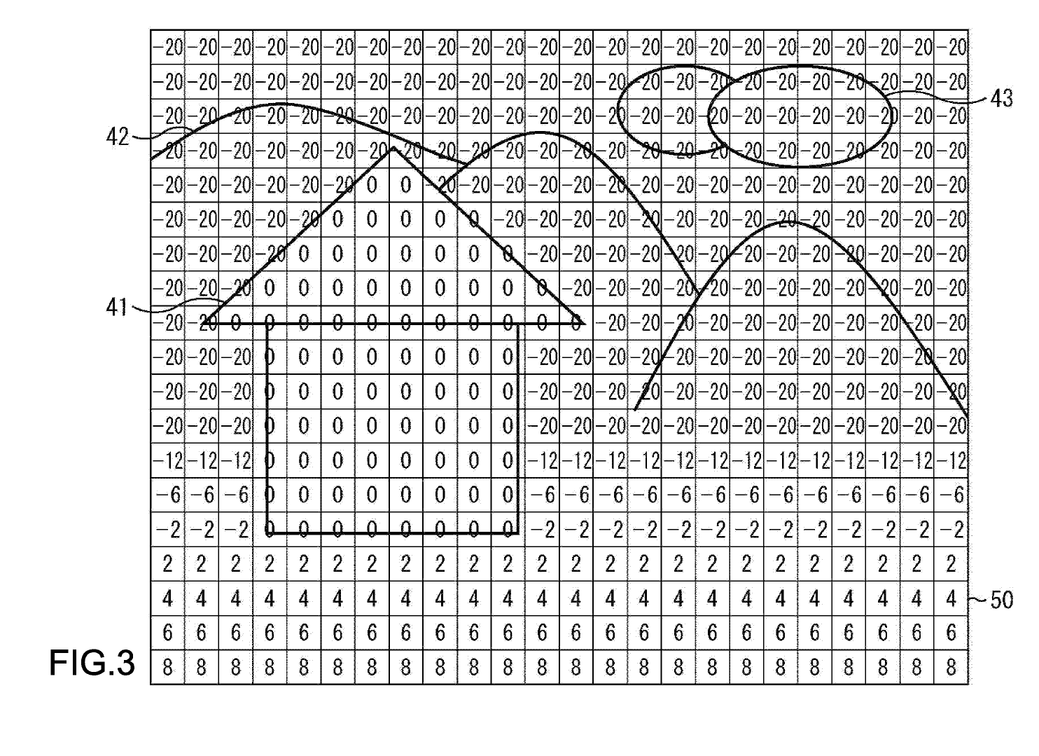

FIG. 3 is a diagram showing an example of a depth map of the taken image 40 of FIG. 2.

Note that, in FIG. 3, for the purpose of illustration, the house 41, the mountains 42, and the cloud 43 are shown on the corresponding positions on the depth map 50. However, the house 41, the mountains 42, and the cloud 43 are not displayed on the depth map 50 actually.

Because the house 41 is in focus in the taken image 40, as shown in FIG. 3, the phase-difference information of the positions on the depth map 50 corresponding to the house 41 is approximately 0 (0 in the example of FIG. 3). Further, because the mountains 42 and the cloud 43 are background, as shown in FIG. 3, the phase-difference information of the positions on the depth map 50 corresponding to the mountains 42 and the cloud 43 is negative (−20 in the example of FIG. 3). Meanwhile, as shown in FIG. 3, the phase-difference information of the positions on the depth map 50 corresponding to objects in front of the house 41 is positive (2, 4, 6, and 8 in the example of FIG. 3).

As described above, the phase-difference information of the house 41, i.e., the in-focus main-object area, is approximately 0. Because of this, an area having the size equal to or larger than an assumed minimum size (a minimum size assumed as the size of the main object of the taken image 40, whose phase-difference information is approximately 0) is detected based on the depth map 50. As a result, the main-object area is detected easily. That is, codes are allocated based on the detected main-object area, whereby the compression processing is optimized easily and the compression processing is performed efficiently and accurately.

(Description of Processing Executed by Image Processing Apparatus)

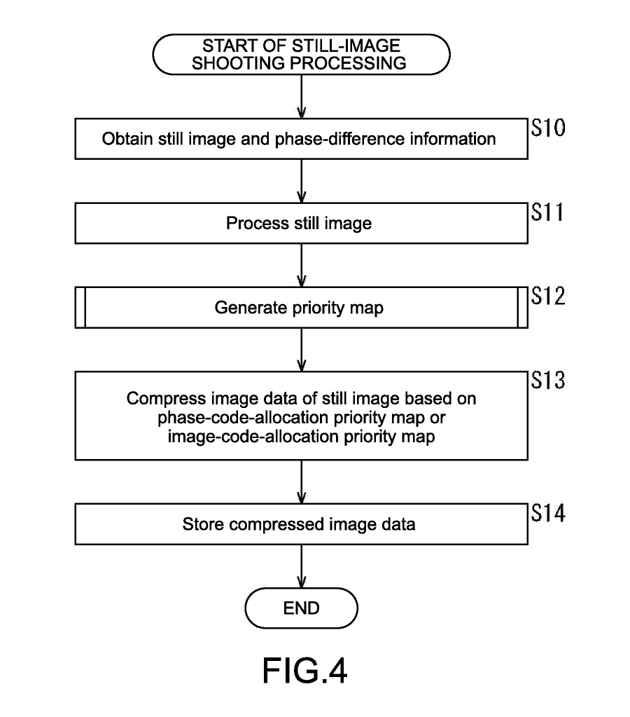

FIG. 4 is a flowchart illustrating the still-image shooting processing executed by the image processing apparatus 10.

In Step S10 of FIG. 4, the image sensor 12 photoelectrically converts light collected by the optical system 11 in pixel unit, to thereby obtain electric signals of the respective pixels of a still image. The image sensor 12 supplies the electric signals to the image processor 13. Further, the phase-difference detecting pixels 12A of the image sensor 12 obtain phase-difference information in a detection unit based on the light collected by the optical system 11. The phase-difference detecting pixels 12A supply the phase-difference information to the phase-difference processor 17.

In Step S11, the image processor 13 performs image processing, e.g., converts analog electric signals of the respective pixels of the still image supplied from the image sensor 12 to digital data of the respective pixels (i.e., image data). The image processor 13 supplies the image data to the compression processor 14 and the microcomputer 18. The microcomputer 18 supplies the image data supplied from the image processor 13 to the memory 19, and stores the image data in the memory 19.

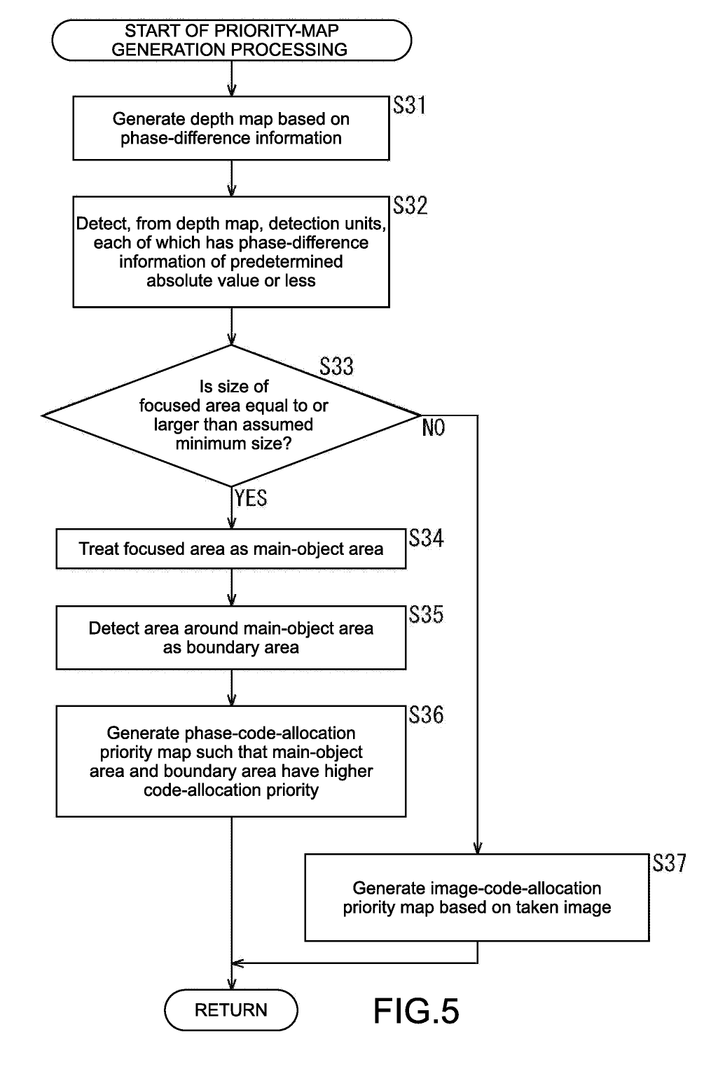

In Step S12, the image processing apparatus 10 generates a code-allocation priority map (i.e., priority-map generation processing). The priority-map generation processing will be described in detail with reference to FIG. 5 (described below).

In Step S13, the compression processor 14 compresses the image data of the still image based on a phase-code-allocation priority map or an image-code-allocation priority map, i.e., a code-allocation priority map generated based on a taken image. The compression processor 14 supplies the compressed image data to the media controller 15.

In Step S14, the media controller 15 controls the storage medium 16, and stores the compressed image data supplied from the compression processor 14 in the storage medium 16. The still-image shooting processing is thus completed.

FIG. 5 is a flowchart illustrating the priority-map generation processing of Step S12 of FIG. 4 in detail.

In Step S31 of FIG. 5, the phase-difference processor 17 generates a depth map including phase-difference information based on the phase-difference information in a detection unit of a taken image supplied from the phase-difference detecting pixels 12A. The phase-difference processor 17 supplies the depth map to the microcomputer 18. The microcomputer 18 supplies the depth map supplied from the phase-difference processor 17 to the memory 19, and stores the depth map in the memory 19.

In Step S32, the microcomputer 18 detects, from the depth map, detection units, each of which has phase-difference information of a predetermined absolute value or less, i.e., approximately 0. The microcomputer 18 treats an area including the detected continuous detection units as a focused area.

In Step S33, the microcomputer 18 determines if the size of at least one focused area is equal to or larger than the assumed minimum size. If it is determined in Step S33 that the size of at least one focused area is equal to or larger than the assumed minimum size, the microcomputer 18 treats the focused area having the size equal to or larger than the assumed minimum size as a main-object area in Step S34.

In Step S35, the microcomputer 18 detects the area around the main-object area as a boundary area.

In Step S36, the microcomputer 18 generates a phase-code-allocation priority map such that the main-object area and the boundary area have higher code-allocation priority. The microcomputer 18 supplies the phase-code-allocation priority map to the compression processor 14. Then the processing returns to Step S12 of FIG. 4 and proceeds to Step S13.

As a result, when image data of a still image is compressed, a larger number of codes are allocated to the main object area and the boundary area. A smaller number of codes are allocated to the area other than those areas. As a result, the image quality of the compressed image data is increased.

Meanwhile, if it is determined in Step S33 that the sizes of all the focused areas are smaller than the assumed minimum size, the processing proceeds to Step S37.

In Step S37, the microcomputer 18 generates an image-code-allocation priority map based on the image data of the taken image in a past manner. The microcomputer 18 supplies the image-code-allocation priority map to the compression processor 14. Then the processing returns to Step S12 of FIG. 4 and proceeds to Step S13.

As a result, when image data of a still image is compressed, for example, a larger number of codes are allocated to areas having high-frequency components, and a smaller number of codes are allocated to areas having no high-frequency component. As a result, the image quality of the compressed image data is increased.

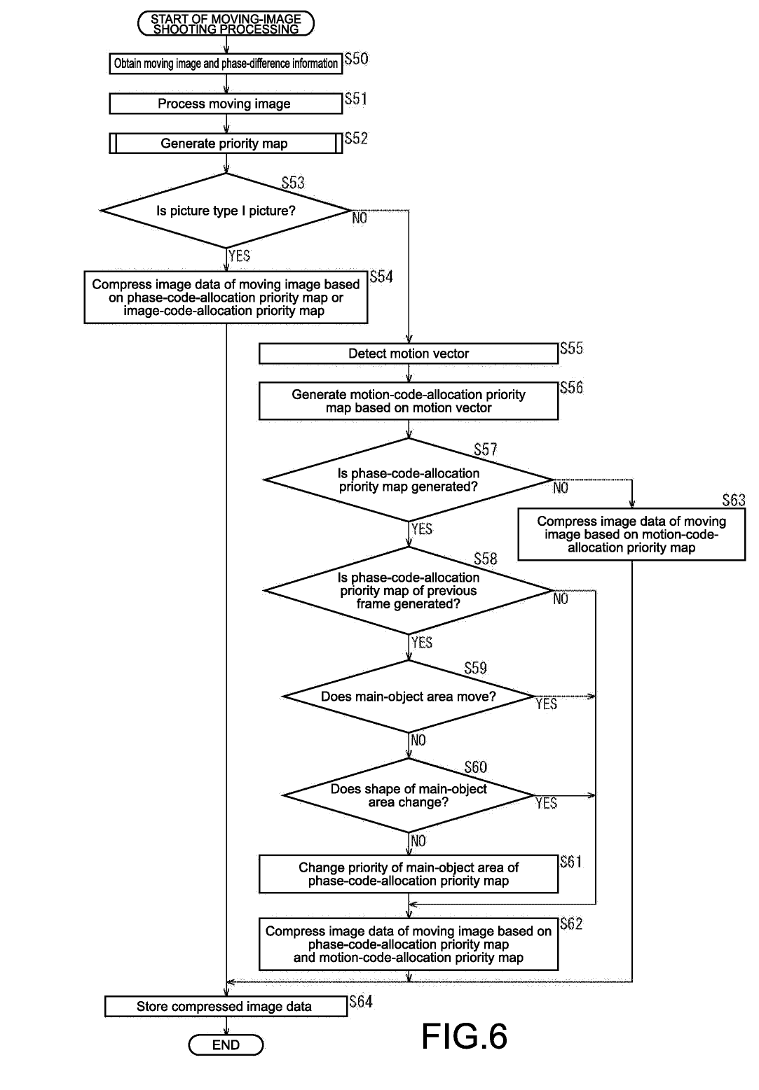

FIG. 6 is a flowchart illustrating the moving-image shooting processing executed by the image processing apparatus 10.

In Step S50 of FIG. 6, the image sensor 12 photoelectrically converts light collected by the optical system 11 in pixel unit, to thereby obtain electric signals of the respective pixels of a moving image. The image sensor 12 supplies the electric signals to the image processor 13. Further, the phase-difference detecting pixels 12A of the image sensor 12 obtain phase-difference information in a detection unit based on the light collected by the optical system 11. The phase-difference detecting pixels 12A supply the phase-difference information to the phase-difference processor 17.

In Step S51, the image processor 13 performs image processing, e.g., converts analog electric signals of the respective pixels of the moving image supplied from the image sensor 12 to digital data of the respective pixels (i.e., image data). The image processor 13 supplies the image data to the compression processor 14 and the microcomputer 18. The microcomputer 18 supplies the image data supplied from the image processor 13 to the memory 19, and stores the image data in the memory 19.

In Step S52, the image processing apparatus 10 executes the priority-map generation processing of FIG. 5.

In Step S53, the microcomputer 18 determines if the picture type of the moving image is the I picture.

If it is determined in Step S53 that the picture type of the moving image is the I picture, the processing proceeds to Step S54. In Step S54, the compression processor 14 compresses the image data of the moving image supplied from the image processor 13 based on the phase-code-allocation priority map or the image-code-allocation priority map supplied from the microcomputer 18.

As a result, when image data of the I picture is compressed, a larger number of codes are allocated to the main object area and the boundary area. A smaller number of codes are allocated to the area other than those areas. As a result, the image quality of the compressed image data is increased. The compression processor 14 supplies the compressed image data to the media controller 15. The processing proceeds to Step S64.

Meanwhile, if the picture type is not the I picture in Step S53, i.e., the picture type is the P picture or the B picture, the processing proceeds to Step S55. In Step S55, for example, the microcomputer 18 matches image data of the moving image of the current frame to image data of the moving image of the previous frame stored in the memory 19, to thereby detect a motion vector.

In Step S56, the microcomputer 18 generates a motion-code-allocation priority map based on the motion vector. Specifically, the microcomputer 18 generates the motion-code-allocation priority map such that the priority of a motion-boundary area (i.e., a boundary area between an area whose motion vector is 0 and an area whose motion vector is not 0) is high.

That is, because it is unlikely that a motion-boundary area includes an area corresponding to a moving image of the previous frame, codes are allocated to the motion-boundary area preferentially. Meanwhile, because it is likely that the area other than the motion-boundary area is the same as the area indicated by the motion vector in the moving image of the previous frame, codes are not allocated to the motion-boundary area preferentially. The microcomputer 18 supplies the motion-code-allocation priority map to the compression processor 14.

In Step S57, the microcomputer 18 determines if a phase-code-allocation priority map is generated in Step S52.

If it is determined in Step S57 that a phase-code-allocation priority map is generated, in Step S58, the microcomputer 18 determines if a phase-code-allocation priority map of a moving image of the previous frame is generated in the processing of Step S52. If it is determined in Step S58 that a phase-code-allocation priority map of the previous frame is generated, the microcomputer 18 reads the depth map of the previous frame from the memory 19.

Then, in Step S59, the microcomputer 18 determines if the main-object area moves based on the depth map of the previous frame and the main-object area of the current frame detected in Step S52.

Specifically, the microcomputer 18 executes the processing of Step S32 to S34 of FIG. 5, to thereby detect a main-object area from the depth map of the previous frame. If the position of the main-object area of the detected previous frame is different from the position of the main-object area of the current frame detected in Step S52, the microcomputer 18 determines that the main-object area moves. Meanwhile, if the position of the main-object area of the detected previous frame is the same as the position of the main-object area of the current frame detected in Step S52, the microcomputer 18 determines that the main-object area does not move.

If it is determined in Step S59 that the main-object area does not move, in Step S60, the microcomputer 18 determines if the shape of the main-object area changes based on the main-object area of the previous frame and the main-object area of the current frame.

If the shape of the main-object area of the previous frame is the same as the shape of the main-object area of the current frame, if is determined in Step S60 that the shape of the main-object area does not change. The processing proceeds to Step S61.

In Step S61, the microcomputer 18 changes the priority of the main-object area of the phase-code-allocation priority map to a standard value, i.e., the priority of the area other than the main-object area and the boundary area. Note that the microcomputer 18 may change not only the priority of the main-object area but also the priority of the boundary area to the standard value. The microcomputer 18 supplies the changed phase-code-allocation priority map to the compression processor 14. The processing proceeds to Step S62.

Meanwhile, if it is determined in Step S58 that a phase-code-allocation priority map of the previous frame is not generated, the microcomputer 18 supplies the phase-code-allocation priority map generated in Step S52 to the compression processor 14 as it is. Then the processing proceeds to Step S62.

Further, if it is determined in Step S59 that the main-object area moves or if it is determined in Step S60 that the shape of main-object area changes, the microcomputer 18 supplies the phase-code-allocation priority map generated in Step S52 to the compression processor 14 as it is. Then the processing proceeds to Step S62.

In Step S62, the compression processor 14 compresses the image data of the moving image supplied from the image processor 13 based on the phase-code-allocation priority map and the motion-code-allocation priority map supplied from the microcomputer 18.

As a result, when image data of the P picture or B the picture is compressed, a larger number of codes are allocated to a main object area whose shape or position changes, a boundary area, and a motion-boundary area. A smaller number of codes are allocated to the area other than those areas. As a result, the image quality of the compressed image data is increased. The compression processor 14 supplies the compressed image data to the media controller 15. The processing proceeds to Step S64.

Meanwhile, if it is determined in Step S57 that a phase-code-allocation priority map is not generated, in Step S63, the compression processor 14 compresses the image data of the moving image based on the motion-code-allocation priority map.

As a result, when image data of the P picture or the B picture is compressed, a larger number of codes are allocated to a motion-boundary area, and a smaller number of codes are allocated to the area other than the motion-boundary area. As a result, the image quality of the compressed image data is increased.

Note that the compression processor 14 may compress the image data not only based on the motion-code-allocation priority map but also based on the image-code-allocation priority map generated in Step S52. The compression processor 14 supplies the compressed image data to the media controller 15. The processing proceeds to Step S64.

In Step S64, the media controller 15 controls the storage medium 16, and stores the compressed image data supplied from the compression processor 14 in the storage medium 16. The moving-image shooting processing is thus completed.

As described above, the image processing apparatus 10 compresses a moving image of the current frame based on a depth map of the current frame and a depth map of the previous frame. In view of this, for example, if the position or shape of a main-object area changes, the image processing apparatus 10 sets higher code-allocation priority on the main-object area. If the position or shape of a main-object area does not change, the image processing apparatus 10 sets lower code-allocation priority on the main-object area. As a result, the image processing apparatus 10 may compress image data efficiently and accurately. That is, the compression processing is optimized.

Further, the image processing apparatus 10 optimizes the compression processing based on a depth map, whose sample number is smaller than the sample number of a taken image. As a result, the compression processing is performed more easily than the case where the compression processing is optimized based on a taken image.

As a result, the power consumption of the image processing apparatus 10 may be reduced. As a result, a battery (not shown) of the image processing apparatus 10 may be downsized, the battery may be operated for a longer time, the image processing apparatus 10 may be downsized and may be lighter in weight because of a simpler heat-radiation structure, and the cost of the image processing apparatus 10 may be lowered because of the downsized battery. Further, the microcomputer 18 of the image processing apparatus 10 may be downsized.

Further, the image processing apparatus 10 optimizes the compression processing based on phase-difference information, which is obtained by the phase-difference detecting pixels 12A in order to control a focal position Fcs. Because of this, only the minimum number of pieces of hardware may be additionally provided.

Further, the image processing apparatus 10 compresses image data not only based on a phase-code-allocation priority map but also based on a motion-code-allocation priority map. As a result, compression efficiency is increased.

Note that the image processing apparatus 10 may detect a motion vector from a taken image based on a depth map. In this case, the image processing apparatus 10 narrows down a search area of matching of a taken image and the like based on a motion vector detected based on a depth map.

According to this method, the calculation amount of matching may be smaller than the calculation amount of matching in the case where a depth map is not used. In addition, the power consumption of the microcomputer 18 may be reduced, and the circuit may be downsized. Further, a motion vector is estimated based on a depth map, and a motion vector is detected in a search area corresponding to the estimated motion vector. As a result, a motion vector may be detected with a higher degree of accuracy, and codes may be allocated with a higher degree of accuracy.

Further, the image processing apparatus 10 may use a main-object area detected based on a depth map to detect a main-object area in a usual taken image, to thereby determine a main-object area finally. In this case, the processing amount of the main-object area detection processing is smaller than the processing amount in the case where a main-object area detected based on a depth map is not used. The power consumption of the microcomputer 18 may be reduced, and the circuit may be downsized.

Further, the image processing apparatus 10 may not generate a phase-code-allocation priority map based on a depth map, but may generate an image-code-allocation priority map based on a main-object area detected based on a depth map. In this case, for example, the image processing apparatus 10 detects if there are high-frequency components or not in a main-object area with a higher degree of accuracy than in the area other than the main-object area. The image processing apparatus 10 interpolates the result of detecting high-frequency components only in the main-object area.

(Description of Computer According to the Present Disclosure)

The above-mentioned series of processing except for image-pickup processing may be executed by hardware or software. If software executes the series of processing, a program configuring the software is installed in a computer. Here, examples of a computer includes a computer built in dedicated hardware, a general-purpose personal computer, for example, in which various programs are installed, capable of executing various functions, and the like.

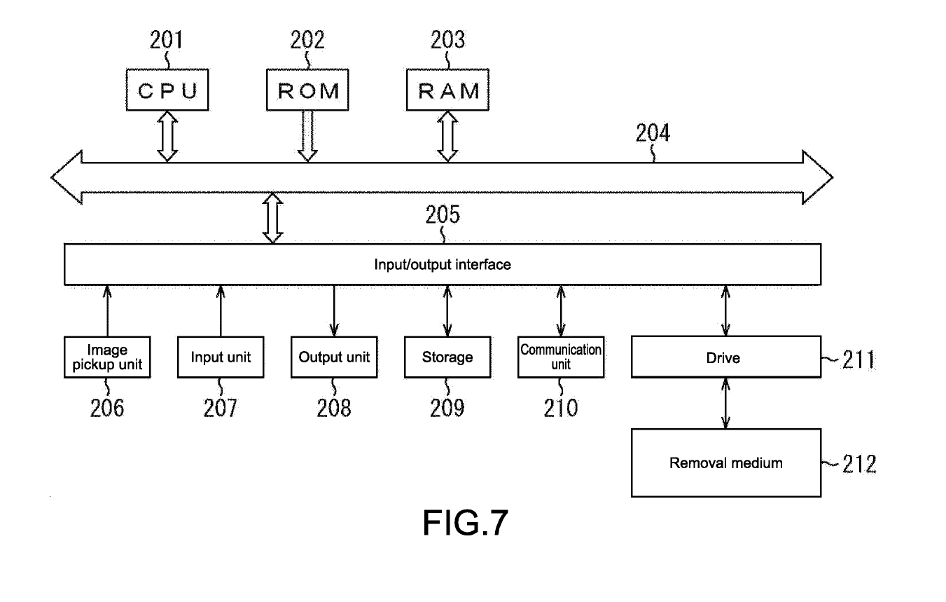

FIG. 7 is a block diagram showing an example of configuration of hardware of a computer, which executes the above-mentioned series of processing in response to a program.

In the computer, the CPU (Central Processing Unit) 201, the ROM (Read Only Memory) 202, and the RAM (Random Access Memory) 203 are connected to each other via the bus 204.

Further, the input/output interface 205 is connected to the bus 204. The image pickup unit 206, the input unit 207, the output unit 208, the storage 209, the communication unit 210, and the drive 211 are connected to the input/output interface 205.

The image pickup unit 206 includes the optical system 11, the image sensor 12, the actuator 20, and the like of FIG. 1. The image pickup unit 206 obtains taken image and phase-difference information. The input unit 207 includes a keyboard, a mouse, a microphone, and the like. The output unit 208 includes a display, a speaker, and the like.

The storage 209 includes a hard disk, a nonvolatile memory, and the like. The communication unit 210 includes a network interface and the like. The drive 211 drives the removal medium 212 such as a magnetic disk, an optical disk, a magnetooptical disk, a storage medium, or a semiconductor memory.

In the computer configured as described above, the CPU 201 loads a program stored in, for example, the storage 209 in the RAM 203 via the input/output interface 205 and the bus 204, and executes the program to thereby execute the above-mentioned series of processing.

For example, the program executed by the computer (the CPU 201) may be stored in the removal medium 212, and provided as a packaged medium or the like.

Further, the program may be provided via a wired/wireless transmission medium such as a local area network, the Internet, or digital satellite broadcasting.

The removal medium 212 may be inserted in the drive 211 of the computer, and the program may thus be installed in the storage 209 via the input/output interface 205. Further, the communication unit 210 may receive the program via a wired/wireless transmission medium, and the program may be installed in the storage 209. Alternatively, the program may be installed in the ROM 202 or the storage 209 previously.

Note that the computer may execute processing in time series in the order described in the specification in response to a program. Alternatively, the computer may execute processing in parallel in response to a program. Alternatively, the computer may execute processing at necessary timing (e.g., when program is called) in response to a program.

Further, the embodiment of the present technology is not limited to the above-mentioned embodiment. The embodiment of the present technology may be variously modified within the scope of the present technology.

For example, the present disclosure may be applied to an image processing apparatus configured to execute image processing such as noise-reduction processing other than the compression processing. If the present disclosure is applied to an image processing apparatus configured to execute noise-reduction processing, for example, change of a scene is detected based on a depth map of the current frame and a depth map of the previous frame. If change of a scene is detected, noise-reduction processing is stopped. As a result, it is possible to prevent an image quality from being deteriorated because of noise-reduction processing at the change of a scene.

Further, the present disclosure may be applied to an image processing apparatus configured to obtain depth information other than phase-difference information in a detection unit, and to compress an image based on the depth information.

For example, the present technology may be configured as cloud computing. In the cloud computing, a plurality of apparatuses share and cooperatively process one function via a network.

Further, one apparatus may execute the steps described with reference to the above-mentioned flowchart. Alternatively, a plurality of apparatuses may share and execute the steps.

Further, if one step includes a plurality of kinds of processing, one apparatus may execute the plurality of kinds of processing in the step. Alternatively, a plurality of apparatuses may share and execute the processing.

Further, the present technology may employ the following structures:

(1) An image processing apparatus, comprising:

an image processor configured to process an image of a first frame based on depth information of the first frame and depth information of a second frame before the first frame, the depth information indicating a position of an object in an image in a depth direction.

(2) The image processing apparatus according to (1), wherein

the depth information is a depth map indicating phase difference of an image.

(3) The image processing apparatus according to (1) or (2), wherein

the image processor is configured to compress the image of the first frame based on the depth information of the first frame and the depth information of the second frame.

(4) The image processing apparatus according to (3), further comprising:

a detecting unit configured
to detect a main-object area in the image of the first frame based on the depth information of the first frame, the main-object area being an area of a main object, and
to detect a main-object area in the image of the second frame based on the depth information of the second frame, wherein

the image processor is configured to compress the image of the first frame based on the main-object area of the first frame and the main-object area of the second frame detected by the detecting unit.

(5) The image processing apparatus according to (4), wherein

the image processor is configured, in a case where the position of the main-object area of the first frame moves from the position of the main-object area of the second frame,
to set a higher code-allocation priority to the main-object area of the first frame, and
to compress the image of the first frame.
   (6) The image processing apparatus according to (4) or (5), wherein

the image processor is configured, in a case where the shape of the main-object area of the first frame is different from the shape of the main-object area of the second frame,
to set a higher code-allocation priority to the main-object area of the first frame, and
to compress the image of the first frame.
   (7) The image processing apparatus according to any one of (4) to (6), wherein

the image processor is configured, in a case where the image of the first frame is different from an I picture, to compress the image of the first frame based on the main-object area of the first frame and the main-object area of the second frame.

(8) The image processing apparatus according to (7), wherein

the image processor is configured, in a case where the image of the first frame is an I picture,

to set a higher code-allocation priority to the main-object area of the first frame, and

to compress the image of the first frame.

(9) An image processing method, comprising:

processing an image of a first frame based on depth information of the first frame and depth information of a second frame before the first frame, the depth information indicating a position of an object in an image in a depth direction.

(10) A program, configured to cause a computer to function as:

an image processor configured to process an image of a first frame based on depth information of the first frame and depth information of a second frame before the first frame, the depth information indicating a position of an object in an image in a depth direction.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
an image processor configured to process an image of a first frame based on depth information of the first frame and depth information of a second frame before the first frame, the depth information indicating a position of an object in an image in a depth direction.

2. The image processing apparatus according to claim 1, wherein
the depth information is a depth map indicating phase difference of an image.

3. The image processing apparatus according to claim 1, wherein
the image processor is configured to compress the image of the first frame based on the depth information of the first frame and the depth information of the second frame.

4. The image processing apparatus according to claim 3, further comprising:
a detecting unit configured
to detect a main-object area in the image of the first frame based on the depth information of the first frame, the main-object area being an area of a main object, and
to detect a main-object area in the image of the second frame based on the depth information of the second frame, wherein
the image processor is configured to compress the image of the first frame based on the main-object area of the first frame and the main-object area of the second frame detected by the detecting unit.

5. The image processing apparatus according to claim 4, wherein
the image processor is configured, in a case where the position of the main-object area of the first frame moves from the position of the main-object area of the second frame,
to set a higher code-allocation priority to the main-object area of the first frame, and
to compress the image of the first frame.

6. The image processing apparatus according to claim 4, wherein
the image processor is configured, in a case where the shape of the main-object area of the first frame is different from the shape of the main-object area of the second frame,
to set a higher code-allocation priority to the main-object area of the first frame, and
to compress the image of the first frame.

7. The image processing apparatus according to claim 4, wherein
the image processor is configured, in a case where the image of the first frame is different from an I picture, to compress the image of the first frame based on the main-object area of the first frame and the main-object area of the second frame.

8. The image processing apparatus according to claim 7, wherein
the image processor is configured, in a case where the image of the first frame is an I picture,
to set a higher code-allocation priority to the main-object area of the first frame, and
to compress the image of the first frame.

9. An image processing method, comprising:
processing an image of a first frame based on depth information of the first frame and depth information of a second frame before the first frame, the depth information indicating a position of an object in an image in a depth direction.

10. A program, configured to cause a computer to function as:
an image processor configured to process an image of a first frame based on depth information of the first frame and depth information of a second frame before the first frame, the depth information indicating a position of an object in an image in a depth direction.
